(19) United States
(12) Patent Application Publication
(10) Pub. No.: US 2021/0004702 A1
(43) Pub. Date: Jan. 7, 2021

(54) SYSTEM AND METHOD FOR GENERATING INFORMATION FOR INTERACTION WITH A USER

(71) Applicant: SAMSUNG ELECTRONICS CO., LTD., Suwon-si, Gyeonggi-do (KR)

(72) Inventors: Miyoung KIM, Suwon-si, Gyeonggi-do (KR); Musik KWON, Suwon-si, Gyeonggi-do (KR); Jonghyun KIM, Suwon-si, Gyeonggi-do (KR)

(21) Appl. No.: 16/979,091

(22) PCT Filed: Mar. 28, 2019
(86) PCT No.: PCT/KR2019/003670

§ 371 Date: Sep. 8, 2020

(30) Foreign Application Priority Data
Mar. 28, 2018 (KR) 10-2018-0036016

(51) Int. Cl. G06N 5/04; G06F 16/9535; G06N 20/00

(52) U.S. Cl. CPC G06N 5/04; G06N 20/00; G06F 16/9535

(57) ABSTRACT

The present disclosure relates to an artificial intelligence (AI) system for simulating functions of the human brain, such as cognition and decision making, by using a machine learning algorithm such as deep learning or the like, and to an application thereof.

A method for generating, by a first interactive electronic device of a first user, information for interaction with the first user includes: receiving, from a second interactive electronic device, information about an interaction between a second user and the second interactive electronic device; and generating interactive information to be provided to the first user, by applying the interactive information provided from the second interactive electronic device to a first AI learning model. At least a part of the method for generating interactive information may use a rule-based model, or an AI model trained according to at least one of a machine learning algorithm, a neural network algorithm, and a deep learning algorithm.

### TECHNICAL FIELD

The present disclosure relates to a system and a method for generating information for an interaction with a user, and more particularly, to a system and a method for allowing an interactive electronic device to generate information for an interaction with a user.

### BACKGROUND ART

Artificial intelligence (AI) systems are computer systems for implementing human-level intelligence, and unlike conventional rule-based smart systems, AI systems get smarter while a machine self-learns and self-determines. The more an AI system is used, the more the AI system's recognition rate improves and the more it can accurately understand user preferences, and thus, conventional rule-based smart systems are gradually being replaced with deep learning-based AI systems.

AI technology includes machine learning (deep learning) and element technologies using the machine learning. Machine learning is an algorithm technology of self-classifying/self-learning features of input data, and element technologies are technologies of simulating functions of the human brain, such as cognition and decision making, by utilizing a machine learning algorithm such as deep learning and include technical fields such as linguistic understanding, visual understanding, inference/prediction, knowledge representation, and motion control.

Various fields to which AI technology is applied are as follows. Linguistic understanding is a technology of recognizing and applying/processing human languages/characters and includes natural language processing, machine translation, interactive system, query response, voice recognition/synthesis, and the like. Visual understanding is a technology of recognizing and processing a thing like human vision and includes object recognition, object tracking, image search, human recognition, scene understanding, space understanding, image enhancement, and the like. Inference/prediction is a technology of determining information and performing logical inference and prediction and includes knowledge/probability-based inference, optimization prediction, preference-based planning, recommendation, and the like. Knowledge representation is a technology of automatically processing human experience information as knowledge data and includes knowledge construction (data creation/classification), knowledge management (data utilization), and the like. Motion control is a technology of controlling autonomous driving of a vehicle and a motion of a robot and includes movement control (navigation, collision avoidance, and traveling), operation control (behavior control), and the like.

In addition, along with the development of AI technology, there is a demand for a technology capable of effectively generating information for an interaction with a particular user by utilizing interactive information of a plurality of users.

### DESCRIPTION OF EMBODIMENTS

### Technical Problem

Provided are an interactive information generation system and method for enabling an interactive electronic device to perform an interaction with a user by using information about an interaction between another interactive electronic device and another user.

In addition, provided are an interactive information generation system and method for enabling an interactive electronic device to filter data transmitted to and received from another interactive electronic device, based on a relationship between a user and another user.

Provided are an interactive information generation system and method for enabling an interactive electronic device to perform an interaction with a user by utilizing a plurality of artificial intelligence (AI) learning models and a plurality of databases (DBs).

### BRIEF DESCRIPTION OF DRAWINGS

FIG. 1 is a block diagram of a system for generating information for an interaction with a user by using an interactive electronic device, according to some embodiments.

FIG. 2 is a flowchart of a method of generating, by a first interactive electronic device, interactive information for an interaction with a first user, according to some embodiments.

FIG. 3 is a signaling diagram of a method of interacting, by a first interactive electronic device, with a first user by using interactive information of the first user and interactive information of a second user, and providing the interactive information of the first user to a second interactive electronic device, according to some embodiments.

FIG. 4 is a table in which a relationship between users and an information sharing level are illustrated, according to some embodiments.

FIG. 5 is a flowchart of a method of acquiring, by a first interactive electronic device, information related to a first user, according to some embodiments.

FIG. 6 is a flowchart of a method of acquiring and using, by a first interactive electronic device, real-time information related to a first user, according to some embodiments.

FIG. 7 is a flowchart of a method of generating, by a first interactive electronic device, interactive information to be provided to a first user, by using an interactive learning model, according to some embodiments.

FIG. 8 is a flowchart of a method of providing, by a first interactive electronic device, interactive information to a first user by using a plurality of interactive learning models, according to some embodiments.

FIG. 9 is an example of a table related to databases (DBs) which a first interactive electronic device uses for an interaction with a first user, according to some embodiments.

FIGS. 10 and 11 illustrate examples in which a first interactive electronic device interacts with a first user by using information received from a second interactive electronic device, according to some embodiments.

FIGS. 12 and 13 are block diagrams of a first interactive electronic device according to some embodiments.

FIG. 14 is a block diagram of a processor according to some embodiments.

FIG. 15 is a block diagram of a data learner according to some embodiments.

FIG. 16 is a block diagram of a data determiner according to some embodiments.

FIG. 17 illustrates an example of learning and recognizing data according to linking between a first interactive electronic device and a server, according to some embodiments.

### BEST MODE

According to a first aspect of the present disclosure, there is provided a method of generating, by a first interactive electronic device of a first user, information for an interaction with the first user, the method including: registering a second interactive electronic device of a second user; receiving, from the second interactive electronic device, information about an interaction between the second user and the second interactive electronic device; and generating interactive information to be provided to the first user, by applying the interactive information provided from the second interactive electronic device to a first artificial intelligence (AI) learning model, wherein the interactive information provided from the second interactive electronic device is generated by the second interactive electronic device by using a second AI learning model in the second interactive electronic device.

According to a second aspect of the present disclosure, there is provided a first interactive electronic device including: a communication unit configured to communicate with a second interactive electronic device; a memory storing at least one instruction; and at least one processor configured to control the first interactive electronic device to generate interactive information to be provided to a first user, wherein the at least one processor is further configured to execute the at least one instruction to: register the second interactive electronic device of a second user; receive, from the second interactive electronic device, information about an interaction between the second user and the second interactive electronic device; and generate the interactive information to be provided to the first user, by applying the interactive information provided from the second interactive electronic device to a first artificial intelligence (AI) learning model, wherein the interactive information provided from the second interactive electronic device is generated by the second interactive electronic device by using a second AI learning model in the second interactive electronic device.

According to a third aspect of the present disclosure, there is provided a computer-readable recording medium having recorded thereon a program for executing, in a computer, the method according to the first aspect.

### Mode of Disclosure

Hereinafter, embodiments of the present disclosure will be described in detail with reference to the accompanying drawings such that those of ordinary skill in the art to which the present disclosure belongs could easily carry out the embodiments. However, the present disclosure could be implemented in various different forms and is not limited to the embodiments described herein. In addition, in the drawings, parts irrelevant to the description are omitted to clearly describe the present disclosure, and like reference numerals denote like elements throughout the specification.

Throughout the specification, when it is described that a certain part is “connected” to another part, it should be understood that the certain part may be “directly connected” or “electrically connected” to another part via another element in the middle. In addition, when a certain part “includes” a certain component, this indicates that the part may further include another component instead of excluding another component unless there is different disclosure.

Hereinafter, the present disclosure will be described in detail with reference to the accompanying drawings.

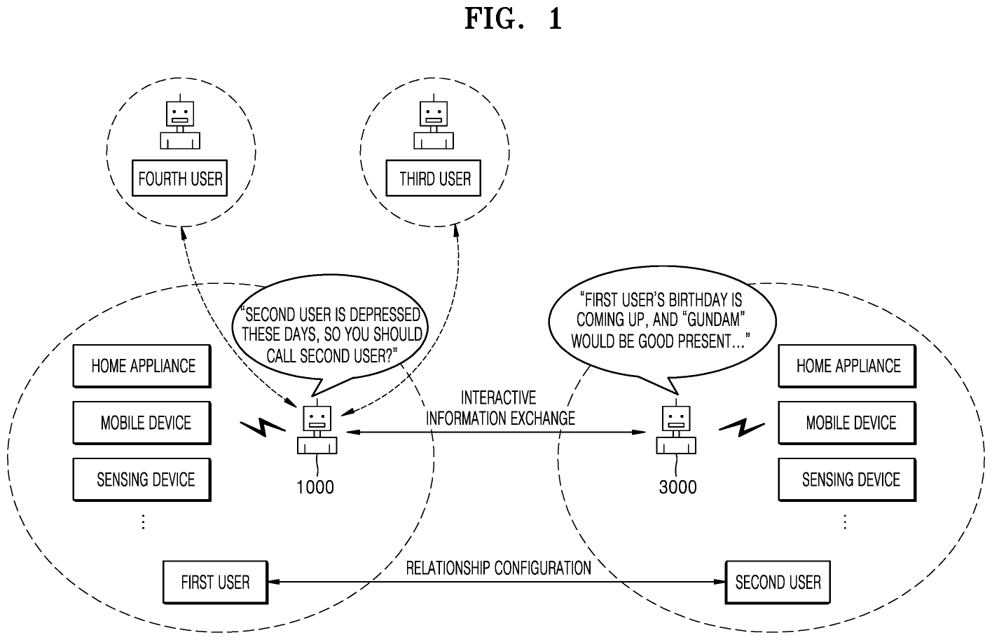

FIG. 1 is a block diagram of a system for generating information for an interaction with a user by using an interactive electronic device, according to some embodiments.

Referring to FIG. 1, in the system for generating information for an interaction with a user, a first interactive electronic device 1000 may interact with a first user, and the first interactive electronic device 1000 may generate and output interactive information suitable for the first user by sharing interactive information with a second interactive electronic device 3000.

The first interactive electronic device 1000 may be an electronic device of the first user, and may communicate with a plurality of devices of the first user and acquire, from the plurality of devices, information needed to generate interactive information for an interaction with the first user. For example, a plurality of devices of a user may include a home appliance, a mobile device, and a sensing device but are not limited thereto. In addition, the first interactive electronic device 1000 may acquire information related to a user service use history from a server (not shown) configured to provide a service which the first user uses.

The first interactive electronic device 1000 may receive interactive information from the second interactive electronic device 3000 of a second user based on a relationship between the first user and the second user. In addition, the first interactive electronic device 1000 may generate interactive information having interactive content suitable for the first user by applying, to an artificial intelligence (AI) learning mode, the interactive information received from the second interactive electronic device 3000, interactive information of the first user, and the information received from the plurality of devices.

The first interactive electronic device 1000 may share interactive information with other interactive electronic devices different from the second interactive electronic device 3000. In this case, the first interactive electronic device 1000 may share interactive information with the second interactive electronic device 3000 and the other interactive electronic devices based on a relationship among users.

The first interactive electronic device 1000 may be an interactive robot device, a smartphone, a tablet personal computer (PC), a PC, a smart TV, a cellular phone, a personal digital assistant (PDA), a laptop computer, a micro-server, a global positioning system (GPS) device, an e-book terminal, a digital broadcast terminal, a navigation machine, an MP3 player, a digital camera, a home appliance, or another mobile or non-mobile computing device but is not limited thereto. In addition, the first interactive electronic device 1000 may be a wearable device, such as a watch, eyeglasses, a hairband, or a ring, having a communication function and a data processing function. However, the first interactive electronic device 1000 is not limited thereto and may all types of devices capable of receiving information from the second interactive electronic device 3000 through a network.

The components of FIG. 1 may transmit and receive data to and from each other through the network. For example, the network may include a local area network (LAN), a wide area network (WAN), a value added network (VAN), a mobile radio communication network, a satellite communication network, and a combination thereof, is a data communication network of an inclusive meaning, which enables each network configuration entity shown in FIG. 1 to smoothly communicate with each other, and may include wired Internet, wireless Internet, and a mobile wireless communication network. In addition, wireless communication may include, for example, wireless LAN (Wi-Fi), Bluetooth, Bluetooth low energy, ZigBee, Wi-Fi Direct (WFD), ultra wideband (UWB), infrared data association (IrDA), near field communication (NFC), and the like but is not limited thereto.

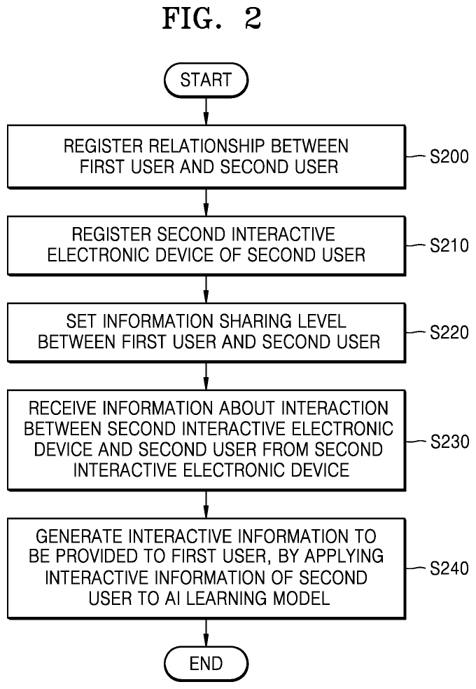

FIG. 2 is a flowchart of a method of generating, by a first interactive electronic device, interactive information for an interaction with a first user, according to some embodiments.

In operation S200, the first interactive electronic device 1000 may register a relationship between the first user and a second user. The first interactive electronic device 1000 may share information with the second interactive electronic device 3000, and to this end, the first interactive electronic device 1000 may register the relationship between the first user and the second user.

The first interactive electronic device 1000 may determine the relationship between the first user and the second user based on an intimacy level between the first user and the second user. The first interactive electronic device 1000 may determine the relationship between the first user and the second user by analyzing interactive content, the number of interactions, a call frequency, and the like between the first user and the second user. However, the first interactive electronic device 1000 is not limited thereto and may determine the relationship between the first user and the second user based on a user input. For example, the relationship between the first user and the second user may include a family relationship, a friend relationship, a co-worker relationship, and an acquaintance relationship but is not limited thereto.

In addition, the first interactive electronic device 1000 may also configure relationships with other users besides the second user. The first interactive electronic device 1000 may configure a relationship with the first user by, for example, grouping at least some of the second user and the other users.

In operation S210, the first interactive electronic device 1000 may register the second interactive electronic device 3000 of the second user, and in operation S220, the first interactive electronic device 1000 may set an information sharing level between the first user and the second user. The first interactive electronic device 1000 may register a user identifier (ID) of the second user and a device ID of the second interactive electronic device 3000 and set the information sharing level of information to be shared between the first user and the second user. In addition, according to the set information sharing level, information to be shared between the first user and the second user may be determined.

The information sharing level between the first user and the second user may include a sharing level of information to be provided from the second user to the first user and a sharing level of information to be provided from the first user to the second user. In addition, at least one of the sharing level of the information to be provided from the second user to the first user and the sharing level of the information to be provided from the first user to the second user may be set by the first interactive electronic device 1000.

The information sharing level may be set based on the relationship between the first user and the second user but is not limited thereto. The information sharing level may be set by a user input. In addition, based on the information sharing level, a type of information to be provided from the second interactive electronic device 3000 to the first interactive electronic device 1000 and a type of information to be provided from the first interactive electronic device 1000 to the second interactive electronic device 3000. The type of the information to be provided from the second interactive electronic device 3000 to the first interactive electronic device 1000 may be the same as or different from the type of the information to be provided from the first interactive electronic device 1000 to the second interactive electronic device 3000.

In operation S230, the first interactive electronic device 1000 may receive, from the second interactive electronic device 3000, information about an interaction between the second interactive electronic device 3000 and the second user. The second interactive electronic device 3000 may select a part of the information about the interaction between the second interactive electronic device 3000 and the second user based on the information sharing level between the first user and the second user and provide the selected information to the first interactive electronic device 1000. In this case, the first interactive electronic device 1000 may provide information about the information sharing level between the first user and the second user to the second interactive electronic device 3000 and request the second interactive electronic device 3000 to provide interactive information. Alternatively, the information sharing level between the first user and the second user may be set in the second interactive electronic device 3000, and the second interactive electronic device 3000 may provide interactive information to the first interactive electronic device 1000 at a preset time point based on the information sharing level between the first user and the second user. Alternatively, the second interactive electronic device 3000 may provide the information about the interaction between the second interactive electronic device 3000 and the second user to the first interactive electronic device 1000, and the first interactive electronic device 1000 may filter a part of the received interactive information based on the information sharing level.

The first interactive electronic device 1000 may receive, from the second interactive electronic device 3000, various pieces of information acquired by the second interactive electronic device 3000 in association with the second user besides the interactive information of the second user.

In operation S240, the first interactive electronic device 1000 may generate interactive information to be provided to the first user, by applying the interactive information of the second user to an AI learning model. The AI learning model may be a learning mode trained for an interaction with a user and may be a learning mode trained using at least one AI algorithm among a machine learning algorithm, a neural network algorithm, a genetic algorithm, a deep learning algorithm, and a classification algorithm. The first interactive electronic device 1000 may generate interactive information for an interaction with the first user by inputting, into the AI learning model, a voice input of the first user together with information related to the first user, which is acquired by the first interactive electronic device 1000, and the interactive information of the second user.

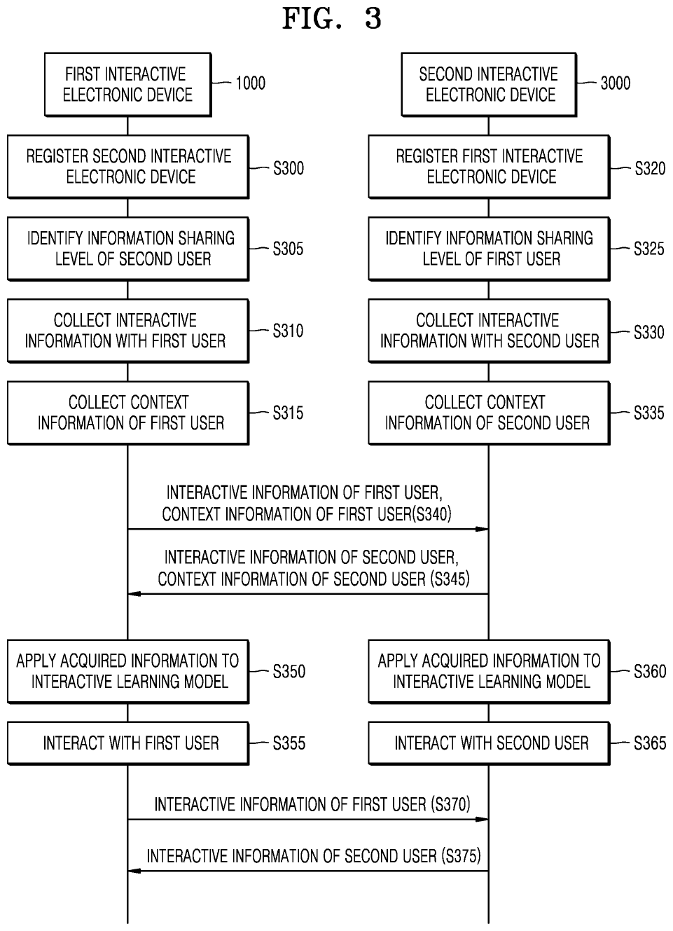

FIG. 3 is a signaling diagram of a method of interacting, by the first interactive electronic device 1000, with a first user by using interactive information of the first user and interactive information of a second user, and providing the interactive information of the first user to the second interactive electronic device 3000, according to some embodiments.

In operation S300, the first interactive electronic device 1000 may generate the second interactive electronic device 3000. While the first interactive electronic device 1000 generates the second interactive electronic device 3000, the first interactive electronic device 1000 may generate the second user and set an information sharing level of information to be provided to the second user.

In operation S305, the first interactive electronic device 1000 may identify an information sharing level of the second user. The information sharing level of the second user may be a sharing level of information to be provided by the first user to the second user.

In operation S310, the first interactive electronic device 1000 may collect interactive information with the first user. The first interactive electronic device 1000 is an electronic device for interacting with the first user and may collect real-time interactive information with the first user during an interaction with the first user. The interactive information with the first user may include, for example, interactive content output from the first interactive electronic device 1000, interactive content input from the first user, and information about an interactive time between the first interactive electronic device 1000 and the first user.

In operation S315, the first interactive electronic device 1000 may collect context information of the first user. The first interactive electronic device 1000 may acquire the context information of the first user from a device of the first user and a server configured to provide a service to which the first user has subscribed.

Context information may include at least one of ambient environment information of a device of a user, state information of the device, state information of the user, device use history information of the user, and schedule information of the user but is not limited thereto. The ambient environment information of the device indicates environment information within a certain radius from the device and may include, for example, weather information, temperature information, humidity information, illuminance information, noise information, sound information, and the like but is not limited thereto. The ambient environment information of the device may include information for identifying other users located around the device. The state information of the device may include operation mode information of the device (e.g., a sound mode, a vibration mode, a mute mode, a power-saving mode, a blocking mode, a multi-window mode, an automatic rotation mode, and the like), position information, time information, activation information of a communication module (e.g., Wi-Fi ON/Bluetooth OFF/GPS ON/NFC ON/the like), network access state information of the device, information about an application executed in the device (e.g., identification information of the application, application type, an application use time, and an application use period), and the like but is not limited thereto. In addition, the device of the user may also include the first interactive electronic device 1000.

The state information of the user is information about a motion, a life pattern, and the like of the user and may include information about a walking state, an exercising state, a driving state, a sleeping state, an emotional state, and the like of the user but is not limited thereto. The device use history information of the user is information about the user's device using history and may include an execution history of an application, a history of a function executed in the application, a position history of the device, a call history of the user, a text history of the user, and the like but is not limited thereto.

In addition, the first interactive electronic device 1000 may monitor the user by using a photographing device and a sensor provided to the first interactive electronic device 1000, thereby acquiring context information of a user. For example, the first interactive electronic device 1000 may photograph a user around the first interactive electronic device 1000 by using a camera and generate information indicating a motion, a gesture, and an expression of the user by analyzing a motion, a gesture, and an expression of the photographed user.

In operation S320, the second interactive electronic device 3000 may register the first interactive electronic device 1000, and in operation S325, the second interactive electronic device 3000 may identify an information sharing level of the first user. The information sharing level of the first user may be a sharing level of information to be provided by the second user to the first user. The information sharing level of the first user may be the same as or different from the information sharing level of the second user

In operation S330, the second interactive electronic device 3000 may collect interactive information with the second user, and in operation S335, the second interactive electronic device 3000 may collect context information of the second user. The second interactive electronic device 3000 may interact with the second user by using an AI learning model in the second interactive electronic device 3000 and collect real-time interactive information with the second user during an interaction with the second user.

In operation S340, the first interactive electronic device 1000 may provide the interactive information of the first user and the context information of the first user to the second interactive electronic device 3000. The first interactive electronic device 1000 may select at least a part of the interactive information of the first user and at least a part of the context information of the first user based on an information sharing level between the first user and the second user and provide the selected information to the second interactive electronic device 3000. The first interactive electronic device 1000 may provide the interactive information of the first user and the context information of the first user to the second interactive electronic device 3000 directly or via a server (not shown).

In operation S345, the second interactive electronic device 3000 may provide the interactive information of the second user and the context information of the second user to the first interactive electronic device 1000. The second interactive electronic device 3000 may select at least a part of the interactive information of the second user and at least a part of the context information of the second user based on the information sharing level between the first user and the second user and provide the selected information to the first interactive electronic device 1000. The second interactive electronic device 3000 may provide the interactive information of the second user and the context information of the second user to the first interactive electronic device 1000 directly or via the server (not shown).

In operation S350, the first interactive electronic device 1000 may apply the acquired information to an interactive learning model. The interactive learning model may be an AI learning model trained for an interaction with a user and may be a model trained using at least one AI algorithm among a machine learning algorithm, a neural network algorithm, a genetic algorithm, a deep learning algorithm, and a classification algorithm. The first interactive electronic device 1000 may generate interactive information for an interaction with the first user by inputting, into the interactive learning model, a voice input of the first user together with the interactive information of the first user, the context information of the first user, the interactive information of the second user, and the context information of the second user The interactive learning model used by the first interactive electronic device 1000 may be present in the first interactive electronic device 1000 or the server (not shown) configured to provide an interactive service.

In operation S355, the first interactive electronic device 1000 may interact with the first user. The first interactive electronic device 1000 may interact with the first user by using the generated interactive information. The first interactive electronic device 1000 may convert the generated interactive information into a voice or a text and output the converted voice or text through an output device of the first interactive electronic device 1000.

In operation S360, the second interactive electronic device 3000 may apply the acquired information to an interactive learning model, and in operation S365, the second interactive electronic device 3000 may interact with the second user. The interactive learning model used by the second interactive electronic device 3000 may be present in the second interactive electronic device 3000 or the server (not shown) configured to provide an interactive service.

In operation S370, the first interactive electronic device 1000 may provide interactive information of the first user to the second interactive electronic device 3000. The first interactive electronic device 1000 may provide interactive information of the first user, which indicates the content of the interaction in operation S355, to the second interactive electronic device 3000.

In operation S375, the second interactive electronic device 3000 may provide interactive information of the second user to the first interactive electronic device 1000. The second interactive electronic device 3000 may provide interactive information of the second user, which indicates the content of the interaction in operation S365, to the first interactive electronic device 1000.

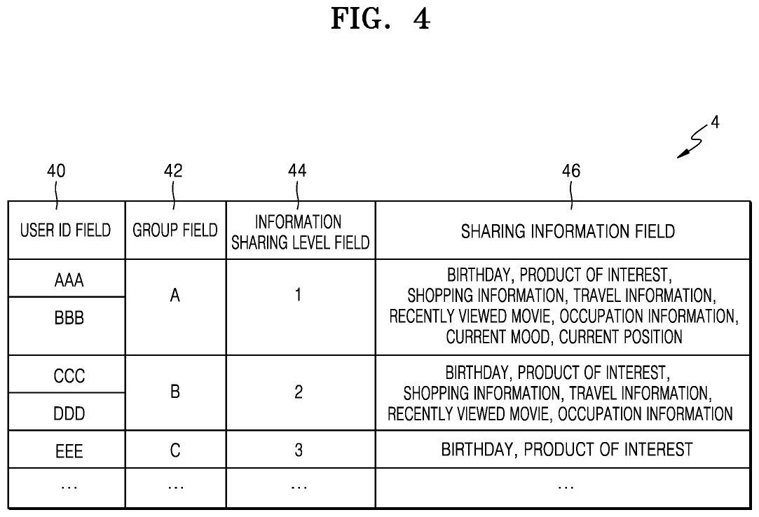

FIG. 4 is a table in which a relationship between users and an information sharing level are illustrated, according to some embodiments.

Referring to FIG. 4, a table 4 in which a relationship between users and an information sharing level are illustrated may include a user ID field 40, a group field 42, an information sharing level field 44, and a sharing information field 46.

The user ID field 40 may include a user ID. The user ID may be a user ID for using an interactive service according to some embodiments of the present disclosure.

The group field 42 may include an identification value of a group to which users belong, and the information sharing level field 44 may include an information sharing level value of information to be shared. A first user may group other users and set an information sharing level for each group but is not limited thereto. The first user may set an information sharing level for each user. Alternatively, a user group and an information sharing level may be automatically set by an AI learning model.

The sharing information field 46 may include types of information to be shared. Types of information to be shared between users may be set for each information sharing level. The types of information to be shared may be set by a user input or a certain AI learning model.

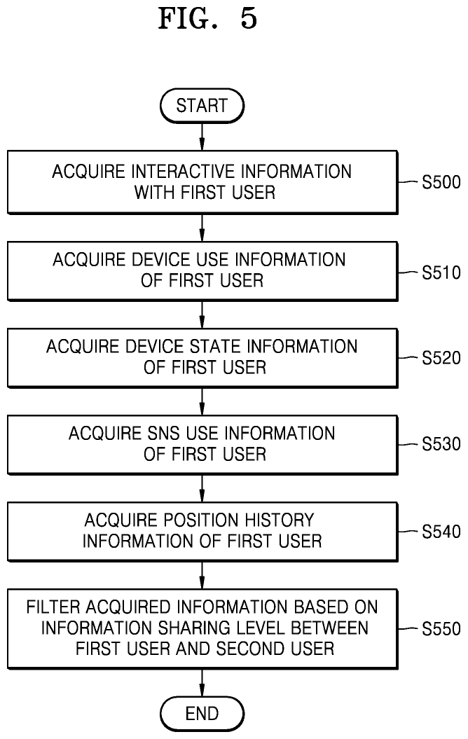

FIG. 5 is a flowchart of a method of acquiring, by a first interactive electronic device, information related to a first user, according to some embodiments.

In operation S500, the first interactive electronic device 1000 may acquire interactive information with the first user. The first interactive electronic device 1000 may interact with the first user by using an interactive learning model and collect real-time interactive information indicating interactive content with the first user.

In operation S510, the first interactive electronic device 1000 may acquire device use information of the first user. The first user may use a home appliance, a mobile device, and the like, and the first interactive electronic device 1000 may receive device use information from the home appliance, the mobile device, and the like in real-time or a preset period.

In operation S520, the first interactive electronic device 1000 may acquire device state information of the first user. The first interactive electronic device 1000 may receive device state information indicating current states of the home appliance, the mobile device, and the like of the first user from the home appliance, the mobile device, and the like in real-time or a preset period.

In operation S530, the first interactive electronic device 1000 may acquire social network service (SNS) use information of the first user. The first interactive electronic device 1000 may receive the SNS use information of the first user from an SNS server which the first user uses or a device used by the first user for an SNS service. The SNS use information may include message data and multimedia data transmitted and received by the first user through the SNS service.

In operation S540, the first interactive electronic device 1000 may acquire position history information of the first user. The first interactive electronic device 1000 may acquire the position history information of the first user by receiving position information from the mobile device of the first user.

In operation S550, the first interactive electronic device 1000 may filter the acquired information based on an information sharing level between the first user and a second user. The first interactive electronic device 1000 may filter the information acquired in operations S500 to S540, based on the information sharing level between the first user and the second user.

In addition, the first interactive electronic device 1000 may process the filtered information in a preset format such that the first interactive electronic device 1000 and the second interactive electronic device 3000 use the filtered information. The first interactive electronic device 1000 may process the filtered information so as to be suitable for an interactive learning model to be used by the first interactive electronic device 1000. Alternatively, the first interactive electronic device 1000 may process the filtered information so as to be suitable for an interactive learning model to be used by the second interactive electronic device 3000. The first interactive electronic device 1000 may filter and process the acquired information by using a certain learning model.

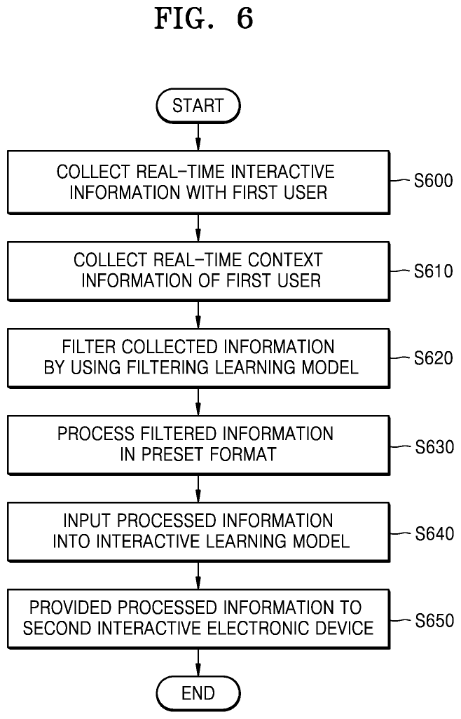

FIG. 6 is a flowchart of a method of acquiring and using, by a first interactive electronic device, real-time information related to a first user, according to some embodiments.

In operation S600, the first interactive electronic device 1000 may collect real-time interactive information with the first user, and in operation S610, the first interactive electronic device 1000 may collect real-time context information with the first user.

In operation S620, the first interactive electronic device 1000 may filter the collected information by using a filtering learning model. The filtering learning model may be an AI learning model for select, summarize, or edit necessary information among the collected information such that the connected information is used by an interactive learning model.

The first interactive electronic device 1000 may use the filtering learning model to acquire information to be input to an interactive learning model in the first interactive electronic device 1000. The first interactive electronic device 1000 may filter interactive information with the first user and context information of the first user by inputting the interactive information with the first user and the context information of the first user into the filtering learning model.

In addition, the first interactive electronic device 1000 may use the filtering learning model to acquire information to be provided to the second interactive electronic device 3000. In this case, the first interactive electronic device 1000 may acquire the information to be provided to the second interactive electronic device 3000, by inputting, for example, the interactive information with the first user, the context information of the first user, and information related to an information sharing level of a second user into the filtering learning model.

In operation S630, the first interactive electronic device 1000 may process the filtered information in a preset format. The first interactive electronic device 1000 may process the filtered information in a format suitable for the interactive learning model in the first interactive electronic device 1000. Alternatively, the first interactive electronic device 1000 may process the filtered information in a format suitable for an interactive learning model in the second interactive electronic device 3000.

Although it has been described in operations S620 and S630 that the collected information is filtered and then processed in the preset format, operations S620 and S630 are not limited thereto. When the collected information is input to the filtering learning model, the collected information may be filtered and processed by the filtering learning model. In this case, the first interactive electronic device 1000 may filter and process the interactive information with the first user and the context information of the first user by inputting, for example, the interactive information with the first user and the context information of the first user into the filtering learning model. In addition, the first interactive electronic device 1000 may select and process the information to be provided to the second interactive electronic device 3000, by inputting, for example, the interactive information with the first user, the context information of the first user, the information related to the information sharing level of the second user, and identification information of an interactive learning model to be used by the second interactive electronic device 3000 into the filtering learning model.

In operation S640, the first interactive electronic device 1000 may input the processed information to the interactive learning model. The first interactive electronic device 1000 may input the processed information, interactive information of the second used, and context information of the second user into the interactive learning model.

In operation S650, the first interactive electronic device 1000 may provide the processed information to the second interactive electronic device 3000. The first interactive electronic device 1000 may provide the processed information to the second interactive electronic device 3000 in real-time or a preset period.

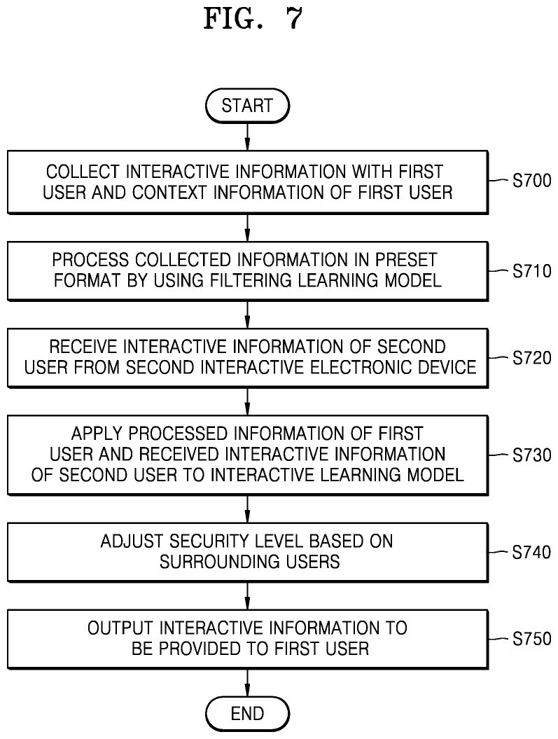

FIG. 7 is a flowchart of a method of generating, by a first interactive electronic device, interactive information to be provided to a first user, by using an interactive learning model, according to some embodiments.

In operation S700, the first interactive electronic device 1000 may collect interactive information of the first user and context information of the first user, and in operation S710, the first interactive electronic device 1000 may filter the collected information and process the filtered information in a preset format by using a filtering learning model.

In operation S720, the first interactive electronic device 1000 may receive interactive information of a second user from the second interactive electronic device 3000. The first interactive electronic device 1000 may receive the interactive information of the second user from the second interactive electronic device 3000 in real-time or a preset period. The first interactive electronic device 1000 may receive context information of the second user from the second interactive electronic device 3000.

In operation S730, the first interactive electronic device 1000 may apply the processed information of the first user and the received interactive information of the second user to the interactive learning model. The interactive learning model used by the first interactive electronic device 1000 may be implemented in the first interactive electronic device 1000 or a separate server (not shown).

For example, the first interactive electronic device 1000 may input the interactive information of the first user, the context information of the first user, the interactive information of the second user, and the context information of the second user into the interactive learning model. In addition, the first interactive electronic device 1000 may input, into the interactive learning model, an interactive voice uttered by the first user during an interaction with the first user.

In addition, the interactive information of the first user, the context information of the first user, the interactive information of the second user, and the context information of the second user may be updated in real-time, and in this case, the first interactive electronic device 1000 may apply the real-time updated information to the interactive learning model. In addition, the first interactive electronic device 1000 may provide the updated interactive information of the first user and the updated context information of the first user to the second interactive electronic device 3000.

In operation S740, the first interactive electronic device 1000 may adjust a security level based on surrounding users. The first interactive electronic device 1000 may adjust a security level of an interaction with the first user by identifying surrounding users. The context information of the first user may include, for example, information for identifying users around the first interactive electronic device 1000 In this case, the first interactive electronic device 1000 may input identification information of surrounding users into the interactive learning model, and the interactive learning model may determine interactive content to be provided to the first user, a volume of an interactive voice, and the like by considering the identification information of the surrounding users.

In operation S750, the first interactive electronic device 1000 may output interactive information to be provided to the first user. The first interactive electronic device 1000 may output interactive content as a voice or a text. The first interactive electronic device 1000 may adjust a volume of an interactive voice to be provided to the first user, by considering the identification information of the surrounding users, a distance between the first interactive electronic device 1000 and the first user, and the like.

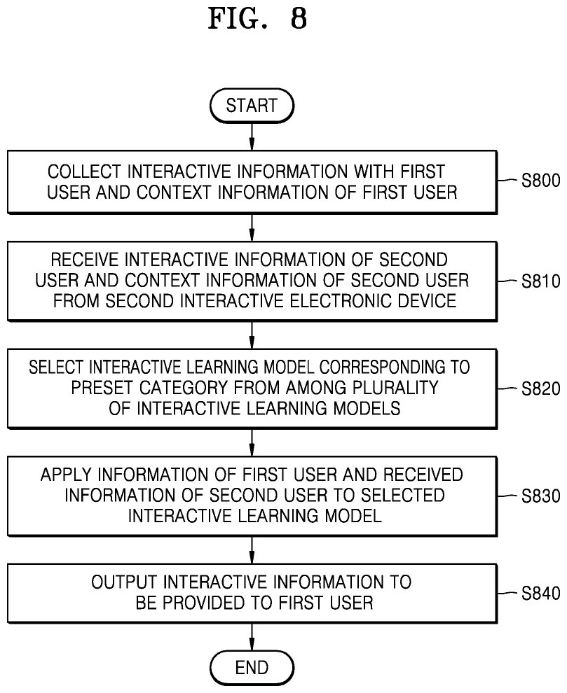

FIG. 8 is a flowchart of a method of providing, by a first interactive electronic device, interactive information to a first user by using a plurality of interactive learning models, according to some embodiments.

In operation S800, the first interactive electronic device 1000 may collect interactive information with the first user and context information of the first user, and in operation S810, the first interactive electronic device 1000 may receive interactive information with a second user from the second interactive electronic device 3000.

In operation S820, the first interactive electronic device 1000 may select an interactive learning model corresponding to a preset interaction category from among the plurality of interactive learning models. There may be exist the plurality of interactive learning models which the first interactive electronic device 1000 is usable for an interaction with the first user, and the plurality of interactive learning models may correspond to a plurality of interaction categories, respectively. The interaction categories may include, for example, a business category, a daily life category, a family category, a friend category, and the like but are not limited thereto. In addition, an interactive learning model may be trained by being specialized for an interaction category corresponding to the interactive learning model.

The first interactive electronic device 1000 may select an interactive learning model to be used for an interaction with the first user, by considering at least one of a group of the second user, a relationship with the second user, and an information sharing level of the second user.

In operation S830, the first interactive electronic device 1000 may apply the information about the first user and the information about the second user to the selected interactive learning model. The first interactive electronic device 1000 may filter, based on the interaction category, a part of the information acquired in operation S800 and a part of the information acquired in operation S810 and input the filtered information to the selected interactive learning model.

In operation S840, the first interactive electronic device 1000 may output interactive information to be provided to the first user.

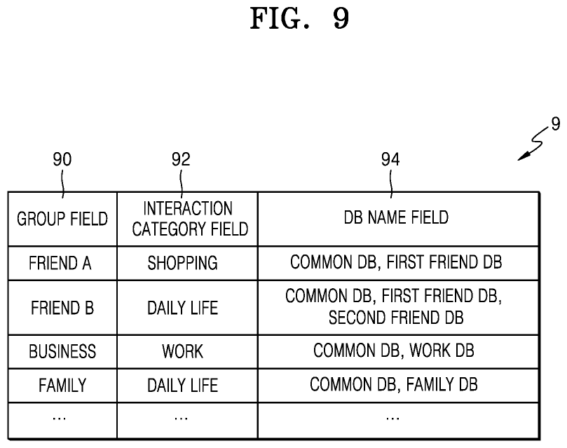

FIG. 9 is an example of a table related to databases (DBs) which a first interactive electronic device uses for an interaction with a first user, according to some embodiments.

Referring to FIG. 9, a table 9 related to DBs which the first interactive electronic device 1000 uses for an interaction with the first user may include a group filed 90, an interaction category field 92, and a DB name field 94.

The group filed 90 may include an identification value of a group to which a second user belongs. The group filed 90 may include, for example, a friend A, a friend B, and a family but is not limited thereto.

The interaction category field 92 may include an identification value of an interaction category to be selected by the first interactive electronic device 1000 when the first interactive electronic device 1000 interacts with the first user by considering interactive information of the second user. The interaction category field 92 may include, for example, shopping, daily life, and work but is not limited thereto.

The DB name field 94 may include identification values of DBs which the first interactive electronic device 1000 is usable when the first interactive electronic device 1000 interacts with the first user by considering interactive information of the second user or provide information related to the first user to the second interactive electronic device 3000.

A plurality of DBs which the first interactive electronic device 1000 is usable may be classified by considering a security level, an interaction category, a group, and the like, and the information related to the first user and information related to the second user may be filtered according to a preset reference and stored in at least one of the plurality of DBs.

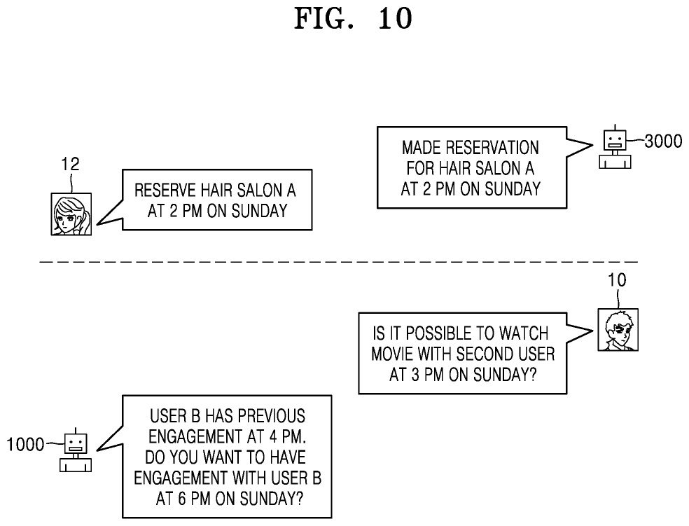

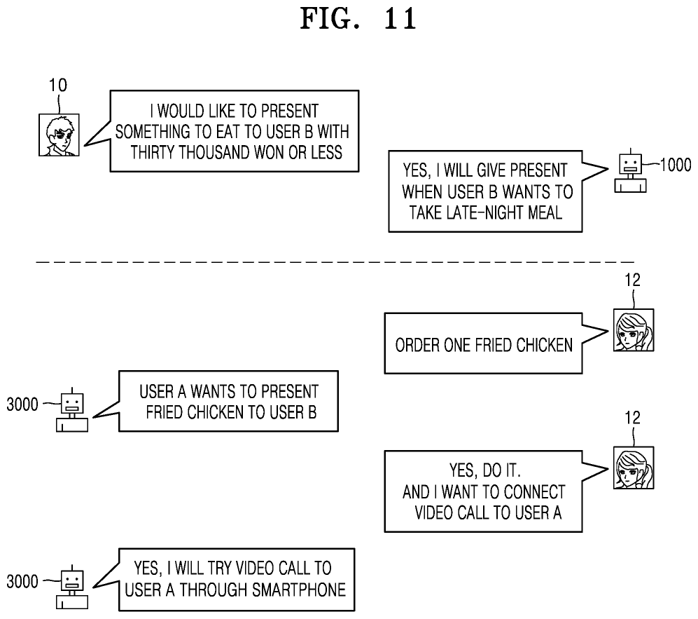

FIGS. 10 and 11 illustrate examples in which the first interactive electronic device 1000 interacts with a first user by using information received from the second interactive electronic device 3000, according to some embodiments.

Referring to FIG. 10, a user B 12 may request the second interactive electronic device 3000 for “Reserve a hair salon A at 2 PM on Sunday.”, and the second interactive electronic device 3000 may reserve the hair salon A for the user B 12 in response to the request of the user B 12. In addition, the second interactive electronic device 3000 may output, to the user B 12, a sound “made a reservation for the hair salon A at 2 PM on Sunday”. In addition, the second interactive electronic device 3000 may provide, to the first interactive electronic device 1000, interactive information indicating interactive content with the user B 12.

Thereafter, a user A 10 may tell the first interactive electronic device 1000 “Is it possible to watch a movie with a second user at 3 PM on Sunday?”. The first interactive electronic device 1000 may output a sound “User B has a previous engagement at 4 PM. Do you want to have an engagement with user B at 6 PM on Sunday?” based on interactive information of the user B 12, which is received from the second interactive electronic device 3000.

Referring to FIG. 11, the user A 10 may tell the first interactive electronic device 1000 “I would like to present something to eat to user B with thirty thousand Won or less”, and the first interactive electronic device 1000 may output a sound “Yes, I will give a present when user B wants to take a late-night meal”. In addition, the first interactive electronic device 1000 may provide, to the second interactive electronic device 3000, interactive information indicating interactive content with the user A 10.

Thereafter, when the user B 12 tells the second interactive electronic device 3000 “Order one fried chicken”, the second interactive electronic device 3000 may output a sound “User A wants to present a fried chicken to user B”. In addition, when the user B 12 tells the second interactive electronic device 3000 “Yes, do it. And I want to connect a video call to user A”, the second interactive electronic device 3000 may request and receive, from the first interactive electronic device 1000, data for receiving one fried chicken as a gift. In addition, the second interactive electronic device 3000 may request a mobile device (not shown) of the user B 12 that the mobile device (not shown) of the user B 12 makes a video call to the user A 10.

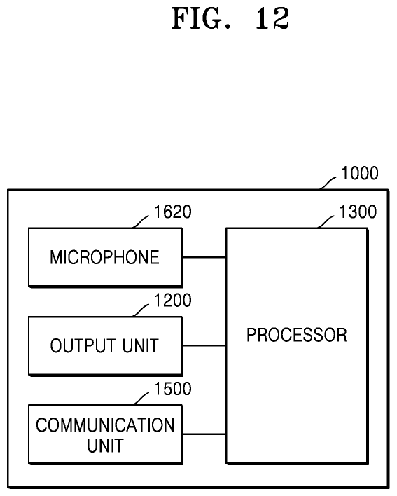

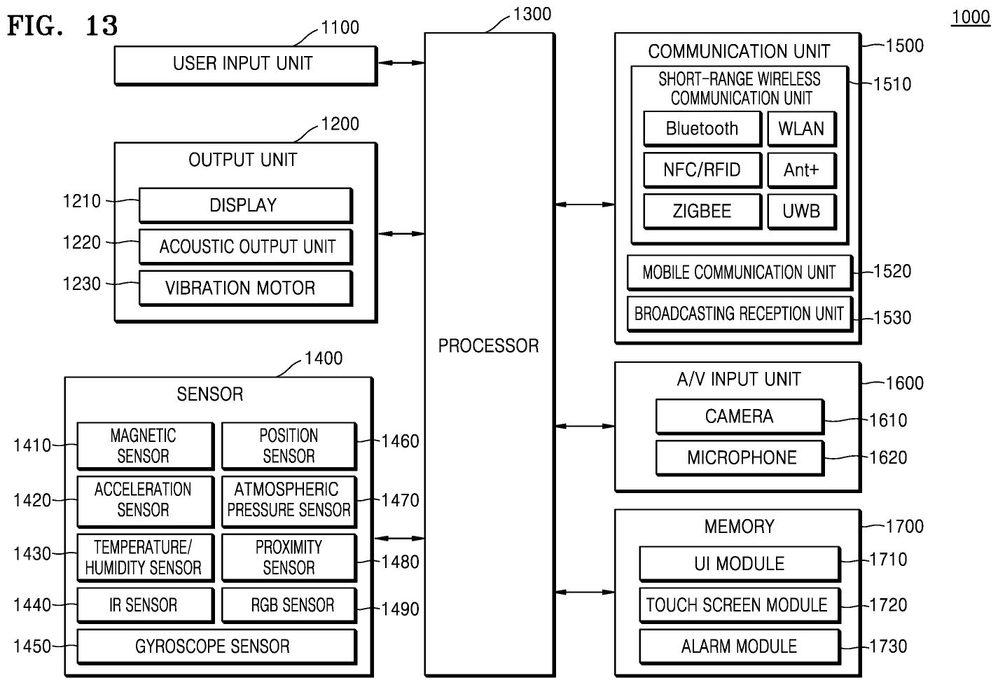

FIGS. 12 and 13 are block diagrams of a first interactive electronic device according to some embodiments.

As shown in FIG. 12, the first interactive electronic device 1000 according to some embodiments may include a microphone 1620, an output unit 1200, a processor 1300, and a communication unit 1500. However, all of the components shown in FIG. 12 are not essential components of the first interactive electronic device 1000. The first interactive electronic device 1000 may be implemented by more or less components than the components shown in FIG. 12.

For example, as shown in FIG. 13, the first interactive electronic device 1000 according to some embodiments may further include a user input unit 1100, a sensor 1400, an audio/video (NV) input unit 1600, and a memory 1700 besides the microphone 1620, the output unit 1200, the processor 1300, and the communication unit 1500.

The user input unit 1100 may indicate a means through which a user inputs data for controlling the first interactive electronic device 1000. For example, the user input unit 1100 may include a keypad, a dome switch, a touch pad (a capacitive overlay touch pad, a resistive overlay touch pad, an infrared (IR) beam touch pad, a surface acoustic wave touch pad, an integral strain gauge touch pad, a piezoelectric touch pad, or the like), a jog wheel, a jog switch, and the like but is not limited thereto.

The user input unit 1100 may receive a user input needed to generate interactive information to be provided to a first user.

The output unit 1200 may output an audio signal, a video signal, or a vibration signal and may include a display 1210, an acoustic output unit 1220, and a vibration motor 1230.

The display 1210 displays information processed by the first interactive electronic device 1000. For example, the display 1210 may display a user interface to be used to generate interactive information to be provided to the first user.

When the display 1210 and a touch pad form a layer structure to configure a touchscreen, the display 1210 may be used as not only an output device but also an input device. The display 1210 may include at least one of a liquid crystal display, a thin-film transistor liquid crystal display, an organic light-emitting diode display, a flexible display, a three-dimensional (3D) display, or an electrophoretic display.

The acoustic output unit 1220 may output audio data received through the communication unit 1500 or stored in the memory 1700. In addition, the acoustic output unit 1220 may output an acoustic signal related to a function (e.g., a call signal reception sound, a message reception sound, or an alarm sound) performed by the first interactive electronic device 1000. The acoustic output unit 1220 may include a speaker, a buzzer, and the like.

The vibration motor 1230 may output a vibration signal. For example, the vibration motor 1230 may output a vibration signal corresponding to an output of audio data or video data (e.g., a call signal reception sound, a message reception sound, or the like).

The processor 1300 may commonly control a general operation of the first interactive electronic device 1000 such that the first interactive electronic device 1000 performs the functions of the first interactive electronic device 1000 in FIGS. 1 to 11. For example, the processor 1300 may generally control the user input unit 1100, the output unit 1200, the sensor 1400, the communication unit 1500, the A/V input unit 1600, and the like by executing programs stored in the memory 1700.

In detail, the processor 1300 may register a relationship between the first user and a second user. The processor 1300 may share information with the second interactive electronic device 3000, and to this end, the processor 1300 may register the relationship between the first user and the second user. The processor 1300 may determine the relationship between the first user and the second user based on an intimacy level between the first user and the second user. The processor 1300 may determine the relationship between the first user and the second user by analyzing interactive content, the number of interactions, a call frequency, and the like between the first user and the second user. However, the processor 1300 is not limited thereto and may determine the relationship between the first user and the second user based on a user input. In addition, the processor 1300 may also configure relationships with other users besides the second user. The processor 1300 may configure a relationship with the first user by, for example, grouping at least some of the second user and the other users.

The processor 1300 may register the second interactive electronic device 3000 of the second user and set an information sharing level between the first user and the second user. The processor 1300 may register a user ID of the second user and a device ID of the second interactive electronic device 3000 and set the information sharing level of information to be shared between the first user and the second user.

The processor 1300 may control the communication unit 1500 to receive, from the second interactive electronic device 3000, information about an interaction between the second interactive electronic device 3000 and the second user. The processor 1300 may select a part of the information about the interaction between the second interactive electronic device 3000 and the second user based on the information sharing level between the first user and the second user and provide the selected information to the first interactive electronic device 1000. The processor 1300 may receive, from the second interactive electronic device 3000, various pieces of information acquired by the second interactive electronic device 3000 in association with the second user besides the interactive information of the second user.

The processor 1300 may generate interactive information to be provided to the first user, by applying the interactive information of the second user to an AI learning model. The AI learning model may be a learning model trained for an interaction with a user and may be a learning model trained using at least one AI algorithm among a machine learning algorithm, a neural network algorithm, a genetic algorithm, a deep learning algorithm, and a classification algorithm. The processor 1300 may generate interactive information for an interaction with the first user by inputting, into the AI learning model, a voice input of the first user together with information related to the first user, which is acquired by the first interactive electronic device 1000, and the interactive information of the second user.

The processor 1300 may provide the interactive information of the first user and the context information of the first user to the second interactive electronic device 3000. The processor 1300 may select at least a part of the interactive information of the first user and at least a part of the context information of the first user based on the information sharing level between the first user and the second user and provide the selected information to the second interactive electronic device 3000. The processor 1300 may provide the interactive information of the first user and the context information of the first user to the second interactive electronic device 3000 directly or via a server (not shown).

The processor 1300 may filter the collected information by using a filtering learning model. The filtering learning model may be an AI learning model for select, summarize, or edit necessary information among the collected information such that the connected information is used by an interactive learning model. The processor 1300 may use the filtering learning model to acquire information to be input to an interactive learning model in the first interactive electronic device 1000. The processor 1300 may filter the interactive information with the first user and the context information of the first user by inputting the interactive information with the first user and the context information of the first user into the filtering learning model.

In addition, the processor 1300 may use the filtering learning model to acquire information to be provided to the second interactive electronic device 3000. In this case, the processor 1300 may acquire the information to be provided to the second interactive electronic device 3000, by inputting, for example, the interactive information with the first user, the context information of the first user, and information related to an information sharing level of the second user into the filtering learning model.

The processor 1300 may process the filtered information in a preset format. The processor 1300 may process the filtered information in a format suitable for the interactive learning model in the first interactive electronic device 1000. Alternatively, the processor 1300 may process the filtered information in a format suitable for an interactive learning model in the second interactive electronic device 3000.

Although it has been described above that the processor 1300 filters the collected information and then processes the filtered information in the preset format, the processor 1300 is not limited thereto. When the collected information is input to the filtering learning model, the collected information may be filtered and processed by the filtering learning model. In this case, the processor 1300 may filter and process the interactive information with the first user and the context information of the first user by inputting, for example, the interactive information with the first user and the context information of the first user into the filtering learning model. In addition, the processor 1300 may select and process the information to be provided to the second interactive electronic device 3000, by inputting, for example, the interactive information with the first user, the context information of the first user, the information related to the information sharing level of the second user, and identification information of an interactive learning model to be used by the second interactive electronic device 3000 into the filtering learning model.

The processor 1300 may select an interactive learning model corresponding to a preset interaction category from among a plurality of interactive learning models. There may be exist the plurality of interactive learning models which the processor 1300 is usable for an interaction with the first user.

The sensor 1400 may detect a state of the first interactive electronic device 1000 or an ambient state of the first interactive electronic device 1000 and transmit the detected information to the processor 1300.

The sensor 1400 may include at least one of a magnetic sensor 1410, an acceleration sensor 1420, a temperature/humidity sensor 1430, an IR sensor 1440, a gyroscope sensor 1450, a position sensor (e.g., GPS) 1460, an atmospheric pressure sensor 1470, a proximity sensor 1480, or an RGB (illuminance) sensor 1490 but is not limited thereto. A function of each sensor may be intuitively inferred by those of ordinary skill in the art from a name thereof, and thus a detailed description thereof is omitted herein.

The communication unit 1500 may include at least one component for communicating between another device. For example, the communication unit 1500 may include a short-range wireless communication unit 1510, a mobile communication unit 1520, and a broadcast reception unit 1530.

The short-range wireless communication unit 1510 may include a Bluetooth communication unit, a Bluetooth low energy (BLE) communication unit, a near-field communication unit, a wireless local area network (WLAN) (Wi-Fi) communication unit, a ZigBee communication unit, an IrDA communication unit, a WFD communication unit, a UWB communication unit, an Ant+ communication unit, and the like but is not limited thereto.

The mobile communication unit 1520 transmits and receives a wireless signal to and from at least one of a base station, an external terminal, and a server in a mobile communication network. Herein the wireless signal may include a voice call signal, a video call signal, or various types of data according to text/multimedia message transmission and reception.

The broadcast reception unit 1530 receives a broadcast signal and/or broadcast related information from the outside through a broadcast channel. The broadcast channel may include a satellite channel and a terrestrial channel. According to implementation examples, the first interactive electronic device 1000 may not include the broadcast reception unit 1530.

In addition, the communication unit 1500 may transmit and receive, to and from the second interactive electronic device 3000, another device, and a server, information needed to generate interactive information to be provided to the first user.

The A/V input unit 1600 is to input an audio signal or a video signal and may include a camera 1610, the microphone 1620, and the like. The camera 1610 may acquire an image frame of a still image, a moving picture, or the like through an image sensor in a video call mode or a capturing mode. An image captured through the image sensor may be processed by the processor 1300 or a separate image processor (not shown).

The image frame processed by the camera 1610 may be stored in the memory 1700 or transmitted to the outside through the communication unit 1500. Two or more cameras 1610 may be provided according to a configuration aspect of a terminal.

The microphone 1620 receives an external acoustic signal and processes the external acoustic signal into electrical voice data. For example, the microphone 1620 may receive an acoustic signal from an external device or a speaker. The microphone 1620 may use various noise cancellation algorithms for cancelling noise generated in a process of receiving an external acoustic signal.

The memory 1700 may store programs for processing and control of the processor 1300 and store data input to the first interactive electronic device 1000 or output from the first interactive electronic device 1000.

The memory 1700 may include at least one type of storage medium among a flash memory type memory, a hard disk type memory, a multimedia card micro type memory, a card type memory (e.g., a secure digital (SD) or extreme digital (XD) memory), random access memory (RAM), static RAM (SRAM), read only memory (ROM), electrically erasable programmable ROM (EEPROM), PROM, a magnetic memory, a magnetic disc, and an optical disc.

The programs stored in the memory 1700 may be classified into a plurality of modules according to functions thereof, e.g., a user interface (UI) module 1710, a touchscreen module 1720, an alarm module 1730, and the like.

The UI module 1710 may provide a specified UI, a specified graphics UI (GUI), or the like interoperating with the first interactive electronic device 1000 for each application. The touchscreen module 1720 may sense a touch gesture of the user on the touchscreen and transmit information regarding the touch gesture to the processor 1300. According to some embodiments, the touchscreen module 1720 may determine and analyze a touch code. The touchscreen module 1720 may be configured by separate hardware including a controller.

The alarm module 1730 may generate a signal for informing of the occurrence of an event of the first interactive electronic device 1000. Examples of the event occurring in the first interactive electronic device 1000 may include call signal reception, message reception, key signal input, schedule notification, and the like. The alarm module 1730 may output an alarm signal in a video signal form through the display 1210, an audio signal form through the acoustic output unit 1220, or a vibration signal form through the vibration motor 1230.

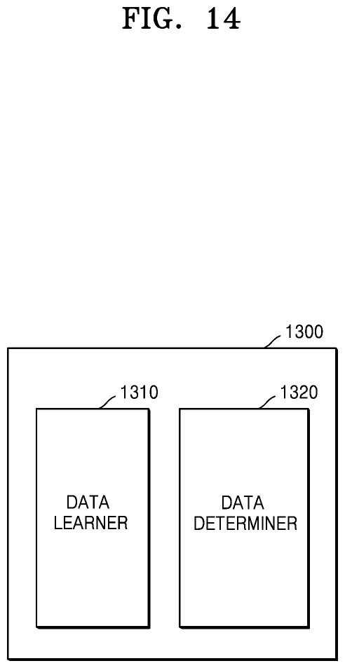

FIG. 14 is a block diagram of a processor according to some embodiments.

Referring to FIG. 14, the processor 1300 according to some embodiments may include a data learner 1310 and a data determiner 1320.

The data learner 1310 may learn a reference to generate interactive content to be provided to the first user. The data learner 1310 may learn a reference regarding which data is to be used to generate the interactive content to be provided to the first user and how to determine, by using the data, the interactive content to be provided to the first user. The data learner 1310 may learn the reference for generating the interactive content to be provided to the first user, by acquiring data to be used for the learning and applying the acquired data to a data recognition model to be described below.

In addition, the data learner 1310 may learn a reference regarding how to filter and process interactive information of the first user, context information of the first user, interactive information of the second user, and context information of the second user. The data learner 1310 may learn a reference regarding which information between the interactive information of the first user and the context information of the first user is provided to the second interactive electronic device 3000. The data learner 1310 may provide the functions of the learning models used by the first interactive electronic device 1000 in FIGS. 1 to 11, and the functions of the learning models used by the first interactive electronic device 1000 in FIGS. 1 to 11 may be implemented by one or more data learners 1310.

The data determiner 1320 may generate the interactive content to be provided to the first user. The data determiner 1320 may generate the interactive content to be provided to the first user, by using a trained AI learning model. The data determiner 1320 may generate the interactive content to be provided to the first user, based on certain data by acquiring the certain data according to a preset reference by the learning and using the AI learning model with the acquired data as an input value. In addition, a result value output by the AI learning model by using the acquired data as an input value may be used to update the AI learning model.

At least one of the data learner 1310 and the data determiner 1320 may be manufactured in a form of at least one hardware chip and equipped in an electronic device. For example, at least one of the data learner 1310 and the data determiner 1320 may be manufactured in a form of exclusive hardware chip for an AI, or manufactured as a part of an existing general-use processor (e.g., a central processing unit (CPU) or an application processor) or a graphic exclusive processor (e.g., a graphic processing unit (GPU)) and may be equipped in various types of electronic devices described above.

In this case, the data learner 1310 and the data determiner 1320 may be equipped in one electronic device or respectively equipped in individual electronic devices. For example, one of the data learner 1310 and the data determiner 1320 may be included in an electronic device, and the other one may be included in a server. In addition, in a wired or wireless manner between the data learner 1310 and the data determiner 1320, model information constructed by the data learner 1310 may be provided to the data determiner 1320, and data input to the data determiner 1320 may be provided as additional learning data to the data learner 1310.

Alternatively, at least one of the data learner 1310 and the data determiner 1320 may be implemented as a software module. When at least one of the data learner 1310 and the data determiner 1320 is implemented as a software module (or a program module including instructions), the software module may be stored in a non-transitory computer-readable recording medium. In addition, in this case, at least one software module may be provided by an operating system (OS) or a certain application. Alternatively, a part of the at least one software module may be provided by the OS, and the other part may be provided by the certain application.

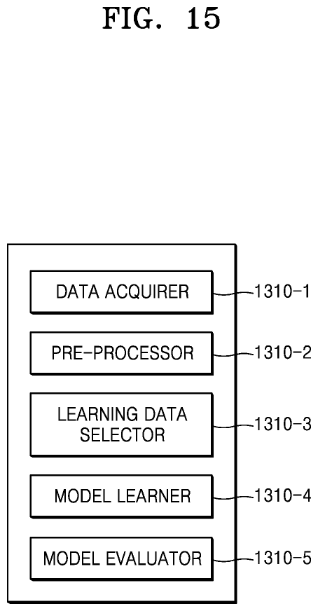

FIG. 15 is a block diagram of a data learner according to some embodiments.

Referring to FIG. 15, the data learner 1310 according to some embodiments may include a data acquirer 1310-1, a pre-processor 1310-2, a learning data selector 1310-3, a model learner 1310-4, and a model evaluator 1310-5.

The data acquirer 1310-1 may acquire data required to generate interactive content to be provided to the first user. The data acquirer 1310-1 may acquire data required for learning to generate interactive content to be provided to the first user. The data acquirer 1310-1 may acquire, for example, interactive information of the first user, context information of the first user, interactive information of the second user, and context information of the second user.

The pre-processor 1310-2 may pre-process the acquired data such that the acquired data is used for learning to generate interactive content to be provided to the first user. The pre-processor 1310-2 may process the acquired data in a preset format such that the model learner 1310-4 to be described below uses the acquired data for learning to generate interactive content to be provided to the first user.

For example, the pre-processor 1310-2 may filter and process the interactive information of the first user, the context information of the first user, the interactive information of the second user, and the context information of the second user by using the AI learning model.

The learning data selector 1310-3 may select data required for learning from among the pre-processed data. The selected data may be provided to the model learner 1310-4. The learning data selector 1310-3 may select data required for learning from among the pre-processed data according to a preset reference for generation of interactive content. Alternatively, the learning data selector 1310-3 may select data according to a reference preset by learning in the model learner 1310-4 to be described below. Alternatively, for example, the learning data selector 1310-3 may select data required for learning by using the AI learning model.

The model learner 1310-4 may learn, based on learning data, a reference regarding how to determine interactive content to be provided to the first user. In addition, the model learner 1310-4 may learn a reference regarding which learning data is to be used to generate interactive content to be provided to the first user.

In addition, the model learner 1310-4 may train, by using learning data, the AI learning model to be used to generate interactive content. In this case, the AI learning model may be previously constructed. For example, the AI learning model may be a model previously constructed by receiving basic learning data (e.g., a sample image and the like).

The AI learning model may be constructed by considering an application field of a recognition model (the learning model), a purpose of learning, a computing performance of a device, or the like The AI learning model may be a model based on a neural network. For example, a deep neural network (DNN), a recurrent neural network (RNN), a bidirectional recurrent deep neural network (BRDNN), or the like may be used as the AI learning model, but the AI learning model is not limited thereto.

According to various embodiments, when there exist a plurality of pre-constructed AI learning models, the model learner 1310-4 may determine, as an AI learning model to be trained, an AI learning model having a high relation of basic learning data with input learning data. In this case, the basic learning data may be pre-classified for each data type, and the AI learning models may be pre-classified for each data type. For example, the basic learning data may be pre-classified based on various references such as a generation region of learning data, a generation time of the learning data, a size of the learning data, a genre of the learning data, a generator of the learning data, and a type of an object in the learning data.

Alternatively, the model learner 1310-4 may train the AI learning model by using, for example, a learning algorithm including error back-propagation or gradient descent.

Alternatively, the model learner 1310-4 may train the AI learning model through, for example, supervised learning of which an input value is learning data. Alternatively, the model learner 1310-4 may train the AI learning model through, for example, unsupervised learning by which a reference for certain determination is discovered by learning, by the model learner 1310-4, a type of data required for the certain determination without a separate supervision. Alternatively, the model learner 1310-4 may train the AI learning model through, for example, reinforcement learning using a feedback on whether a determination result according to learning is right.

In addition, when the AI learning model is trained, the model learner 1310-4 may store the trained AI learning model. In this case, the model learner 1310-4 may store the trained AI learning model in a memory of an electronic device including the data determiner 1320. Alternatively, the model learner 1310-4 may store the trained AI learning model in the memory of the electronic device including the data determiner 1320 to be described below. Alternatively, the model learner 1310-4 may store the trained AI learning model in a memory of a server connected to an electronic device via a wired or wireless network.

In this case, the memory in which the trained AI learning model is stored may also store, for example, a command or data related to at least one other component of the electronic device. In addition, the memory may store software and/or programs. The programs may include, for example, a kernel, middleware, an application programming interface (API), application programs (or “applications”), and/or the like.

The model evaluator 1310-5 may input evaluation data to the AI learning model, and when a recognition result output based on the evaluation data does not satisfy a certain reference, the model evaluator 1310-5 may allow the model learner 1310-4 to perform learning again. In this case, the evaluation data may be preset data for evaluating the AI learning model.

At least one of the data acquirer 1310-1, the pre-processor 1310-2, the learning data selector 1310-3, the model learner 1310-4, and the model evaluator 1310-5 in the data learner 1310 may be manufactured in a form of at least one hardware chip and equipped in an electronic device. For example, at least one of the data acquirer 1310-1, the pre-processor 1310-2, the learning data selector 1310-3, the model learner 1310-4, and the model evaluator 1310-5 may be manufactured in a form of exclusive hardware chip for an AI, or manufactured as a part of an existing general-use processor (e.g., a CPU or an application processor) or a graphic exclusive processor (e.g., a GPU) and may be equipped in various types of electronic devices described above.

In addition, the data acquirer 1310-1, the pre-processor 1310-2, the learning data selector 1310-3, the model learner 1310-4, and the model evaluator 1310-5 may be equipped in one electronic device or respectively equipped in individual electronic devices. For example, some of the data acquirer 1310-1, the pre-processor 1310-2, the learning data selector 1310-3, the model learner 1310-4, and the model evaluator 1310-5 may be included in an electronic device, and the other some may be included in a server.

Alternatively, at least one of the data acquirer 1310-1, the pre-processor 1310-2, the learning data selector 1310-3, the model learner 1310-4, and the model evaluator 1310-5 may be implemented as a software module. When at least one of the data acquirer 1310-1, the pre-processor 1310-2, the learning data selector 1310-3, the model learner 1310-4, and the model evaluator 1310-5 is implemented as a software module (or a program module including instructions), the software module may be stored in a non-transitory computer-readable recording medium. In addition, in this case, at least one software module may be provided by an OS or a certain application. Alternatively, a part of the at least one software module may be provided by the OS, and the other part may be provided by the certain application.

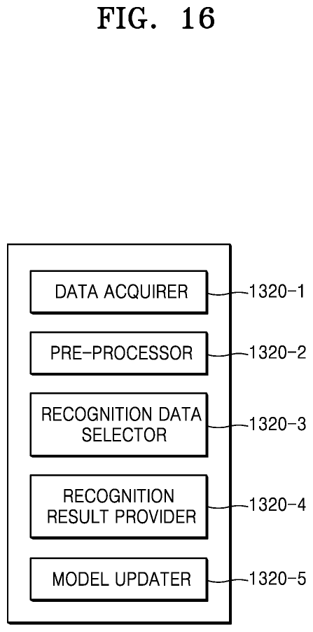

FIG. 16 is a block diagram of a data determiner according to some embodiments.

Referring to FIG. 16, the data determiner 1320 according to some embodiments may include a data acquirer 1320-1, a pre-processor 1320-2, a recognition data selector 1320-3, a recognition result provider 1320-4, and a model updater 1320-5.

The data acquirer 1320-1 may acquire data required to generate interactive content to be provided to the first user, and the pre-processor 1320-2 may pre-process the acquired data such that the acquired data is used to generate interactive content to be provided to the first user. The pre-processor 1320-2 may process the acquired data in a preset format such that the recognition result provider 1320-4 to be described below uses the acquired data to generate interactive content.

The recognition data selector 1320-3 may select, from among the pre-processed data, data required to generate interactive content to be provided to the first user. The selected data may be provided to the recognition result provider 1320-4. The recognition data selector 1320-3 may select a part or all of the pre-processed data according to a preset reference for generation of first interactive content. Alternatively, the recognition data selector 1320-3 may select data according to a reference preset by learning in the model learner 1310-4 to be described below.

The recognition result provider 1320-4 may generate interactive content to be provided to the first user, by applying the selected data to an AI learning model. The recognition result provider 1320-4 may provide a recognition result according to a recognition purpose of the data. The recognition result provider 1320-4 may apply the selected data to the AI learning model by using the data selected by the recognition data selector 1320-3 as an input value. In addition, the recognition result may be determined by the AI learning model.

The model updater 1320-5 may update the AI learning model based on an evaluation on the recognition result provided by the recognition result provider 1320-4. For example, the model updater 1320-5 may allow the model learner 1310-4 to update the AI learning model by providing the recognition result provided by the recognition result provider 1320-4 to the model learner 1310-4.

At least one of the data acquirer 1320-1, the pre-processor 1320-2, the recognition data selector 1320-3, the recognition result provider 1320-4, and the model updater 1320-5 in the data determiner 1320 may be manufactured in a form of at least one hardware chip and equipped in an electronic device. For example, at least one of the data acquirer 1320-1, the pre-processor 1320-2, the recognition data selector 1320-3, the recognition result provider 1320-4, and the model updater 1320-5 may be manufactured in a form of exclusive hardware chip for an AI, or manufactured as a part of an existing general-use processor (e.g., a CPU or an application processor) or a graphic exclusive processor (e.g., a GPU) and may be equipped in various types of electronic devices described above.

In addition, the data acquirer 1320-1, the pre-processor 1320-2, the recognition data selector 1320-3, the recognition result provider 1320-4, and the model updater 1320-5 may be equipped in one electronic device or respectively equipped in individual electronic devices. For example, some of the data acquirer 1320-1, the pre-processor 1320-2, the recognition data selector 1320-3, the recognition result provider 1320-4, and the model updater 1320-5 may be included in the electronic device 100, and the other some may be included in a server.

Alternatively, at least one of the data acquirer 1320-1, the pre-processor 1320-2, the recognition data selector 1320-3, the recognition result provider 1320-4, and the model updater 1320-5 may be implemented as a software module. When at least one of the data acquirer 1320-1, the pre-processor 1320-2, the recognition data selector 1320-3, the recognition result provider 1320-4, and the model updater 1320-5 is implemented as a software module (or a program module including instructions), the software module may be stored in a non-transitory computer-readable recording medium. In addition, in this case, at least one software module may be provided by an OS or a certain application. Alternatively, a part of the at least one software module may be provided by the OS, and the other part may be provided by the certain application.

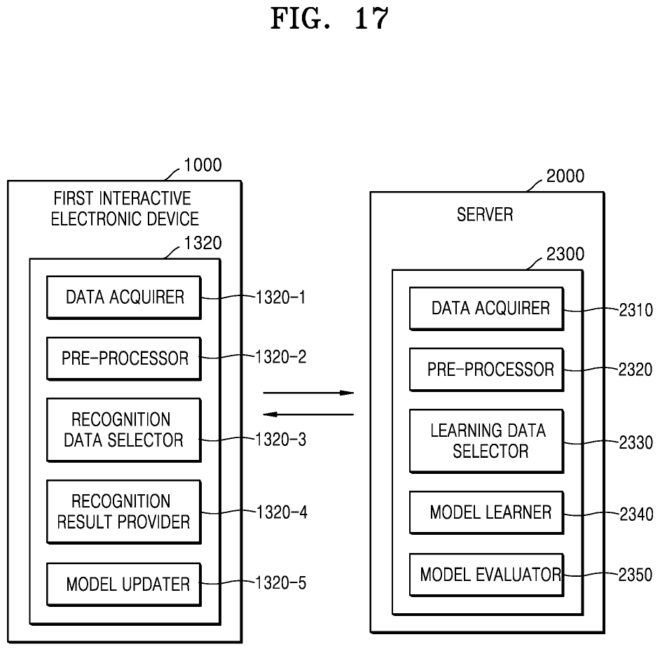

FIG. 17 illustrates an example of learning and recognizing data according to linking between a first interactive electronic device and a server, according to some embodiments.

Referring to FIG. 17, a server 2000 may learn a reference for generating interactive content to be provided to a first user, and the first interactive electronic device 1000 may generate interactive content to be provided to the first user, based on a result of the learning by the server 2000.

In this case, a model learner 2340 of the server 2000 may perform the function of the data learner 1310 shown in FIG. 15. The model learner 2340 of the server 2000 may learn a reference regarding which data is to be used to generate interactive content to be provided to the first user and how to generate the interactive content by using the data. The model learner 2340 may acquire data to be used for the learning, and learn a reference for generating interactive content by applying the acquired data to an AI learning model to be described below.

In addition, the recognition result provider 1320-4 of the first interactive electronic device 1000 may generate interactive content by applying data selected by the recognition data selector 1320-3 to the AI learning model generated by the server 2000. For example, the recognition result provider 1320-4 may transmit the data selected by the recognition data selector 1320-3 to the server 2000 and request the server 2000 to generate interactive content by applying the data selected by the recognition data selector 1320-3 to the AI learning model. In addition, the recognition result provider 1320-4 may receive, from the server 2000, information about interactive content, which is determined by the server 2000.

Alternatively, the recognition result provider 1320-4 of the first interactive electronic device 1000 may receive the AI learning model generated by the server 2000 from the server 2000, and determine a state of the user by using the received recognition model. In this case, the recognition result provider 1320-4 of the device 1000 may generate interactive content by applying the data selected by the recognition data selector 1320-3 to the AI learning model received from the server 2000.

Some embodiments may be implemented in a form of a recording medium including computer-executable instructions such as a program module executed by a computer system. A computer-readable medium may be an arbitrary available medium which may be accessed by a computer system and includes all types of volatile and non-volatile media and separated and non-separated media. In addition, the computer-readable medium may include computer storage media and communication media. The computer storage media include all types of volatile and non-volatile and separated and non-separated media implemented by an arbitrary method or technique for storing information such as computer-readable instructions, a data structure, a program module, or other data. The communication media typically include computer-readable instructions, a data structure, or other data of a modulated signal such as a program module.

In addition, in the present specification, “unit” may indicate a hardware component such as a processor or a circuit and/or a software component executed by a hardware component such as a processor.

The embodiments of the present disclosure described above are only illustrative, and it will be understood by those of ordinary skill in the art to which the present disclosure belongs that various changes in form and details may be made therein without changing the technical spirit and mandatory features of the present disclosure. Therefore, the embodiments described above should be understood in the illustrative sense only and not for the purpose of limitation in all aspects. For example, each component described as a single type may be carried out by being distributed, and likewise, components described as a distributed type may also be carried out by being coupled.

While one or more embodiments of the disclosure have been described with reference to the figures, it will be understood by those of ordinary skill in the art that various changes in form and details may be made therein without departing from the spirit and scope as defined by the following claims.

1. A method of generating, by a first interactive electronic device of a first user, information for an interaction with the first user, the method comprising:
registering a second interactive electronic device of a second user;
receiving, from the second interactive electronic device, information about an interaction between the second user and the second interactive electronic device; and
generating interactive information to be provided to the first user, by applying the interactive information provided from the second interactive electronic device to a first artificial intelligence (AI) learning model,
wherein the interactive information provided from the second interactive electronic device is generated by the second interactive electronic device by using a second AI learning model in the second interactive electronic device.

2. The method of claim 1, further comprising setting an information sharing level between the first user and the second user,
wherein the information about the interaction between the second user and the second interactive electronic device is received from the second interactive electronic device based on the set information sharing level.

3. The method of claim 2, further comprising providing at least a part of the generated interactive information to the second interactive electronic device based on the information sharing level,
Wherein the provided interactive information is used for the second interactive electronic device to generate interactive information to be provided to the second user.

4. The method of claim 3, further comprising acquiring at least one of device use information of the first user, social network service (SNS) use information of the first user, device state information of the first user, and information about a position history of the first user,
wherein the generating of the interactive information to be provided to the first user comprises inputting, into the first AI learning model in the first interactive electronic device, the acquired at least one piece of information together with the interactive information provided from the second interactive electronic device.

5. The method of claim 4, further comprising providing a part of the acquired at least one piece of information to the second interactive electronic device.

6. The method of claim 4, further comprising selecting a part from among the acquired at least one piece of information and the interactive information by applying the acquired at least one piece of information and the interactive information to a third AI learning model,
wherein the selected information is provided to the second interactive electronic device.

7. The method of claim 6, wherein the selected information is processed in a preset format by applying the acquired at least one piece of information and the interactive information to the third AI learning model.

8. The method of claim 1, further comprising selecting the first AI learning model from among a plurality of AI learning models capable of generating the interactive information to be provided to the first user.

9. The method of claim 8, wherein the first AI learning model corresponds to a particular category selected from among a plurality of categories related to a subject of the interactive information to be provided to the first user.

10. The method of claim 1, wherein the first AI learning model is trained using at least one AI algorithm among machine learning, neural network, genetic, deep learning, and classification algorithms.

11. A first interactive electronic device of a first user, for generating information for an interaction with the first user, the first interactive electronic device comprising:
a communication unit configured to communicate with a second interactive electronic device;
a memory storing at least one instruction; and
at least one processor configured to control the first interactive electronic device to generate interactive information to be provided to the first user,
wherein the at least one processor is further configured to execute the at least one instruction to:
register the second interactive electronic device of a second user;
receive, from the second interactive electronic device, information about an interaction between the second user and the second interactive electronic device; and
generate the interactive information to be provided to the first user, by applying the interactive information provided from the second interactive electronic device to a first artificial intelligence (AI) learning model,
wherein the interactive information provided from the second interactive electronic device is generated by the second interactive electronic device by using a second AI learning model in the second interactive electronic device.

12. The first interactive electronic device of claim 11, wherein the at least one processor is further configured to execute the at least one instruction to set an information sharing level between the first user and the second user,
wherein the information about the interaction between the second user and the second interactive electronic device is received from the second interactive electronic device based on the set information sharing level.

13. The first interactive electronic device of claim 12, wherein the at least one processor is further configured to execute the at least one instruction to provide at least a part of the generated interactive information to the second interactive electronic device based on the information sharing level,
wherein the provided interactive information is used for the second interactive electronic device to generate interactive information to be provided to the second user.

14. The first interactive electronic device of claim 13, wherein the at least one processor is further configured to execute the at least one instruction to acquire at least one of device use information of the first user, social network service (SNS) use information of the first user, device state information of the first user, and information about a position history of the first user,
wherein the generating of the interactive information to be provided to the first user comprises inputting, into the first AI learning model in the first interactive electronic device, the acquired at least one piece of information together with the interactive information provided from the second interactive electronic device.

15. A computer-readable recording medium having recorded thereon a program for executing the method of claim 1.
